(19) United States
(12) Patent Application Publication
(10) Pub. No.: US 2001/0035972 A1
(43) Pub. Date: Nov. 1, 2001

(54) Adaptive interface for digital printing systems

(75) Inventor: David K. Wurmfeld, Sudbury, MA (US)

Correspondence Address: JACOBSON HOLMAN PLLC, 400 SEVENTH STREET N.W., SUITE 600, WASHINGTON, DC, 20004, US

(73) Assignee: I-Data International, Inc.

(21) Appl. No.: 09/816,362

(22) Filed: Mar. 26, 2001

Related U.S. Application Data
(63) Continuation of application No. 09/072,213, filed on May 4, 1998, now abandoned.

(51) Int. Cl. G06K 15/02

(52) U.S. Cl. 358/1.13; 358/1.15

(57) ABSTRACT

An adaptive interface for use in conjunction with a digital printing system identifies a user and, based on the user's identity, self-configures into a command-responsive display expressly tailored to the user. The interface displays those system resources most relevant to the particular user based on factors such as authorization level, prior usage patterns, position within an organization, whether the user has jobs pending, or any other characteristics relevant to system utilization. The user is free to directly control the resources presented in the user interface, e.g., by touching icons on the display corresponding to different selections.

### FIELD OF THE INVENTION

The present invention relates to digital printing, and in particular to a network based, print-on-demand system that adapts its display format and offered capabilities to different users.

### BACKGROUND OF THE INVENTION

Conventional electrophotographic copiers are stand-alone machines that receive documents from users, either individually or in bulk, and photocopy these on an immediate basis. The copier can serve no more than a single person at a time, and copy output is local-that is, copies are dispensed directly from the machine as they are produced. As a result, a photocopier can create a significant bottleneck in office operations. Users must wait their turn to operate the machine, which cannot prioritize jobs in terms of length or urgency; the copier simply responds to whomever pushes its ‘start’ button. If multiple copies have been printed, these must be individually distributed to their recipients, some of whom may be physically located far from the machine. Moreover, because copiers are optical devices, multiple copies require redundant scans of the same document; this repetitive operation takes time, and loss of the copy image as it is applied to paper means that the user must wait in line until the copier becomes free, re-feeding the job in order to obtain additional copies later on.

The advent of high-speed scanners and laser printers has opened the possibility of using computational resources to automate the printing process. A digital printing system may include, for example, series of physically dispersed scanners and printers connected to a central print server through a computer network. Through the print server, a user designates a scanner to receive an input document and a printer at which output is to be generated, as well as the characteristics of that output (number of copies, paper type, etc., depending on the capabilities of the selected printer).

In accordance with such “print-on-demand” systems, a document need only be scanned into digital form a single time; it is saved as a file on the print server (or, more typically, on a file-server computer accessible to the print server via the network) and transmitted by the print server to the selected printer in a format readable by its print engine. The print server also transmits instructions concerning the output characteristics. Once again, the data representing the document is transmitted only once.

By transferring supervisory responsibility for a print job to a computer and execution responsibility for input and output to distributed, dedicated devices, new capabilities, as well as substantial efficiencies, can be realized. A user may have access to any of multiple print servers, all of which maintain status information concerning the system's scanners and printers. Accordingly, the user need not await the availability of a central photocopier; instead, she is free to determine, via the print server, which scanner and which printer have the smallest backlog, or which are most conveniently located. In effect, the printers and scanners can be collectively utilized as a non-stop production printing environment.

Moreover, storage of input documents in digital form affords processing options more sophisticated than mere reproduction. The documents may be altered using, for example, text-processing or image-processing software applications at any time; it is not necessary to repeat the input process in order to vary the format of the output. Digitally represented documents may also be sent to destinations other than local printers, e.g., to other network-connected users via local e-mail, or to an Internet server for remote distribution or printing on a remote printer.

As the number of resources—scanners, printers, communication links, etc.—accessible to users of a digital printing system expands, the server's user interface can become quite complex and difficult to use. The number of resources may be large, and not all users necessarily have access to every available resource. Indeed, new users may not even be familiar with the operation of various features, having been trained on standard copiers. An interface tailored to the new user, affording access only to particular resources and the status of his jobs, is unsuited to more experienced or supervisory personnel; yet more complex interfaces reflecting the full diversity of available options and resources may prove cumbersome for any user to operate.

### DESCRIPTION OF THE INVENTION

Brief Summary of the Invention

The present invention provides an adaptive interface for use in conjunction with a digital printing system that identifies a user and, based on the user's identity, self-configures into a command-responsive display expressly tailored to the user. In other words, the interface displays those system resources most relevant to the particular user based on his authorization level, prior usage patterns, position within an organization, whether he has jobs pending, or any other characteristics relevant to system utilization. The user is free to directly control the resources presented in the user interface, e.g., by touching icons on the display corresponding to different selections.

The print server generating the interface accepts and implements the user's commands, sending appropriate instructions to designated resources to effectuate selected actions. The print server also acquires status information from various resources, determining, for example, the backlog queue associated with particular printers and their operational status. The interface may display this status information to the user, and may guide the user in taking ameliorative action to restore a resource to operational effectiveness.

Thus, in a representative embodiment, an adaptive interface in accordance with the present invention is implemented by means of a computer and comprises means for establishing a user's identity (e.g., a badge reader, keypad or touch-screen display through which the user enters an identifier); a database for storing user characteristics; means for causing display (e.g., on a CRT display having touch-screen capability) of a plurality of interface components, which include a representation of at least one available system resource, based on the user characteristics stored in the database; and means for receiving user commands affecting at least one displayed resource. Most simply, the database includes a field somehow categorizing the user, and the interface generates and displays graphical representations of the system resources most likely to be of use.

The database is easily expanded beyond this rudimentary capability, however, to include information such as the resources accessed by the user during his previous session, which are displayed during the current session; resources frequently accessed by the user, even if not accessed during the previous session; a user authority level, which affects not only what is initially displayed, but what the user is able to access through interaction with the display; an interaction language for users whose native language is other than English; a “shortcut” —to stored, network-accessible user document files that the user may select for printing; a record of the user's most recent job request; records of previous job requests as yet unfulfilled; and entertainment preferences specifying audiovisual content to be presented to a user awaiting fulfillment of a job request.

The user makes selections based on the options and resources presented to him based on the database. Selections may be communicated to the system by means of a touch screen, which allows the user to interact directly with the displayed options; of course, other command-entry facilities such as keypads or voice-recognition systems can also be used to advantage. The pattern of the user's interaction with the interface in making a selection and entering data relevant thereto (e.g., the number of copies, the printer location, etc.) is a matter of design choice, and is implemented by conventional interface scripts as well known in the art.

The user need not be physically present at the server with which he interacts. For example, the server may support Internet communications via a suitable data-exchange protocol, such as the HyperText Transfer Protocol used in connection with the World Wide Web (hereafter the “web”). In accordance with this approach, the print server maintains a web page that it serves over the Internet to users contacting the server by means of a web browser. Using conventional CGI scripting and image-map techniques, the web page permits a remote user to make selections based on graphical representations; the user selects elements of the graphical display using a position-sensing device (typically a mouse), and the web page communicates the selection (actually, the two-dimensional coordinates of the selection) to the print server, which takes appropriate action based thereon.

Some representative implementation scenarios will illustrate the flexibility and capabilities of the invention. In an office environment, a print server in accordance with the invention may be equipped with an ultrasonic or infrared sensor, activating the interface upon detection of an approaching user. The server registers the approach of a user and launches the interface, which prompts the user to identify herself by swiping her employee badge through a card reader.

In response to this action, the interface consults the database and determines the user's authorization, usage profile, and personal characteristics or preferences. Suppose, for example, that the user's previous interactions with the system have been limited to copying documents using a high-speed scanner located next to the print server, with the output generated by a printer located near the user's office. The interface generates, on a display equipped with touch-screen capability, the simple image of a copier keypad specifying these resources. The user touches buttons corresponding to the number of copies desired, and places the pages to be copied in the automatic document feed of the scanner. The interface receives image data from the nearby scanner, forwards it to the designated printer, and notifies the user when the job is complete and available for pickup.

Should the user desire an operation other than that expected by the interface, she is free to operate the interface to display the various options open to her given her authorization level. Her selection of a different option will be recorded in the system database and utilized in creating the interface display the next time the user identifies herself to the system. For example, the user may choose to store the digital scan file in a particular network-accessible folder, or forward the file to other employees via e-mail.

Moreover, the interface may be equipped to interact with users in multiple languages, and the database configured to store a preferred interaction language for each user. The database may also provide entertainment to the user as she waits for the job to complete, once again based on preference criteria stored in the database. This feature may allow for the introduction of advertising; for example, the user may select a commercial broadcaster whose transmissions are provided in real-time directly over the interface.

In another scenario, the print server is accessed by a remote terminal configured as a kiosk in a college bookstore. Students identify themselves by means of their ID cards, and the database keeps track of on-account funds that students may apply to copying or printing jobs. For example, students may create document files in their dorms using network computers, storing the files in network-accessible locations (e.g., on a central file server). Interacting with the kiosk, students designate files to be printed and destination locations, approving expenditures of funds from their accounts to cover the costs. Similarly, students may request printouts of reading materials prepared by faculty.

These capabilities could also be made available to students on network computers in their dorms, using, for example, an “intranet” arrangement that allows students to remotely interact with a central print server. In this scenario, the interface display is provided to students as a web page particularized according to the student's database information.

### BRIEF DESCRIPTION OF THE DRAWINGS

The foregoing discussion will be understood more readily from the following detailed description of the invention, when taken in conjunction with the accompanying drawings, in which:

FIG. 1 schematically depicts a representative hardware embodiment of the present invention;

FIG. 2 is a flow chart illustrating procedural operation of the invention in conjunction with a conventional interface;

FIG. 3 is a flow chart illustrating procedural operation of the in conjunction with a web-based interface;

FIG. 4 depicts a digital-copier interface in accordance with the present invention; and

FIG. 5 depicts an options interface in accordance with the present invention.

### DETAILED DESCRIPTION OF THE PREFERRED EMBODIMENTS

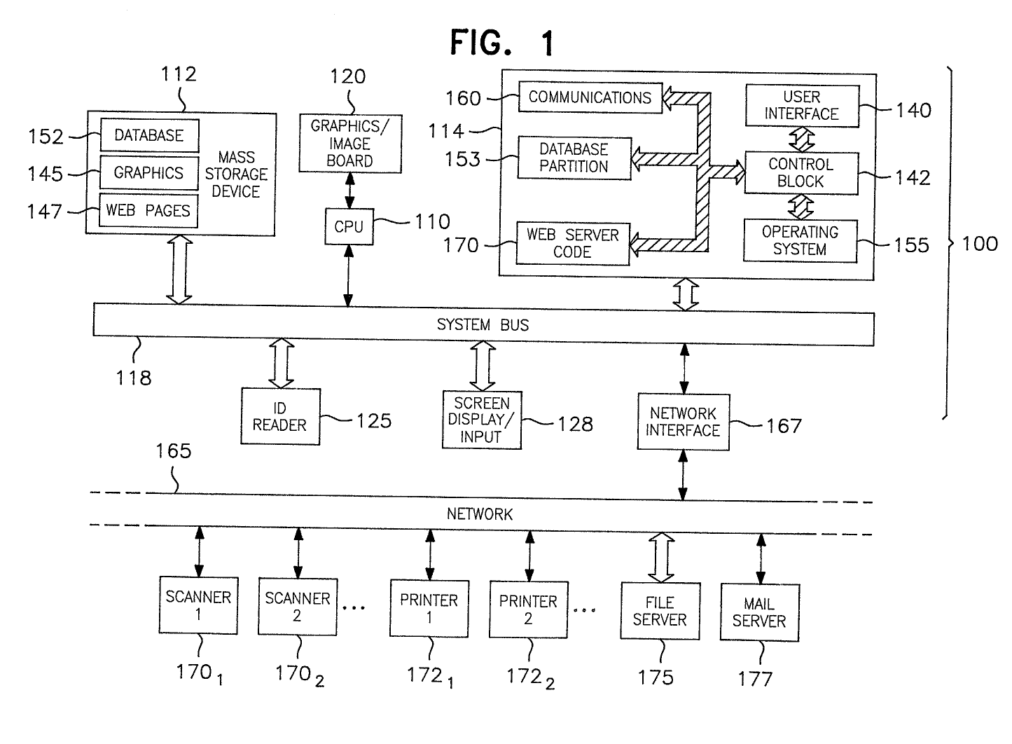

A representative hardware embodiment of a print server in accordance with the present invention is shown in FIG. 1, and includes a central processing unit (“CPU”) 110 and a series of computer storage devices indicated generally at 112, 114. Ordinarily, storage device 112 provides nonvolatile mass storage, and may be, for example, a hard disk and/or CD-ROM drive. Storage 116 comprises a combination of volatile random-access memory (“RAM”) for temporary storage and processing, and non-volatile, programmable read-only memory (“PROM”) that contains permanent aspects of the system's operating instructions.

CPU 110 and computer storage devices 112, 114 communicate over a bidirectional internal system bus 118. To facilitate rapid execution of the graphical operations hereinafter described, the system may contain a graphics or image-processing board 120; this is a standard component well-known to those skilled in the art.

The system 100 also comprises a series of input devices including, at-least, an ID reader 125 that detects and transmits an identifier code contained on a card or badge carried by the user and presented to the device 125, e.g., by swiping through a slot. An input device 128 also connected to I/O bus 118 permits the user to provide information to the system. Preferably, input device 128 is a touch screen that both provides a visual display and allows the user to manually designate information or select particular areas on the display, thereby providing an integrated input/display facility.

Storage 114 contains a series of functional blocks or modules that implement the functions performed by system 100 through operation of CPU 110. A user interface module 140 renders graphical components on touch screen 128, and interprets the raw, two-dimensional touch data provided by touch screen 128; that is, user interface 140 assigns meaning to the user's gestural interactions with touch screen 128 based on the displayed graphical components.

A control block 142 contains computer-executable instructions for assembling the graphical components of touch screen 128 (which are presented by means of user interface module 140) based on the user's identifier, and for implementing the actions requested by the user. Control block 142 may select some of the graphical depictions generated by user interface 140 from a graphics library 145 stored on device 112, or may in some cases directly issue rendering instructions to user interface 140.

In the case of Internet connections, data exchange with a user (or simultaneously with multiple users) is typically effected over the web by means of web pages rather than a conventional user interface. In this case storage device 112 contains a series of web page templates 147, which are implemented as formatting (mark-up) instructions and associated data, and/or so-called “applet” instructions that cause a properly equipped remote computer to present a dynamic display. Management and transmission of a selected web page 147 is handled by a web server module 170, which allows system 100 to function as a web server.

Control block 142 obtains user-specific information from a database 152 stored on device 112, and stores the information in a data partition 153. Database 152 is organized into records consisting of sets of fields or cells, each record corresponding to a particular user; each field of a record corresponds to a user characteristic and may or may not contain data, as described in greater detail below. Control block 142 may also write data to database 152 during and at the conclusion of the user's session with system 100.

Storage 114 also includes an operating system 155, which directs the execution of low-level, basic system functions such as memory allocation, file management and operation of storage device 112. A network communication block 160 provides programming to connect with a computer network 165, which may be a local-area network (“LAN”), a wide-area network (“WAN”), or the Internet. Communication module 160 drives a network interface 167, which contains data-transmission circuitry to transfer streams of digitally encoded data over the communication lines defining network 165.

Also connected to network 165 are a series of resources to which system 100 (and, therefore, a user of system 100) has access. These may include a series of document scanners representatively indicated at 170₁, 170₂; a series of high-speed, high-capacity laser printers representatively indicated at 172₁, 172₂; a file server 175, which contains high-capacity mass storage; and a mail server 177, which transmits text and documents to other network-connected machines as e-mail.

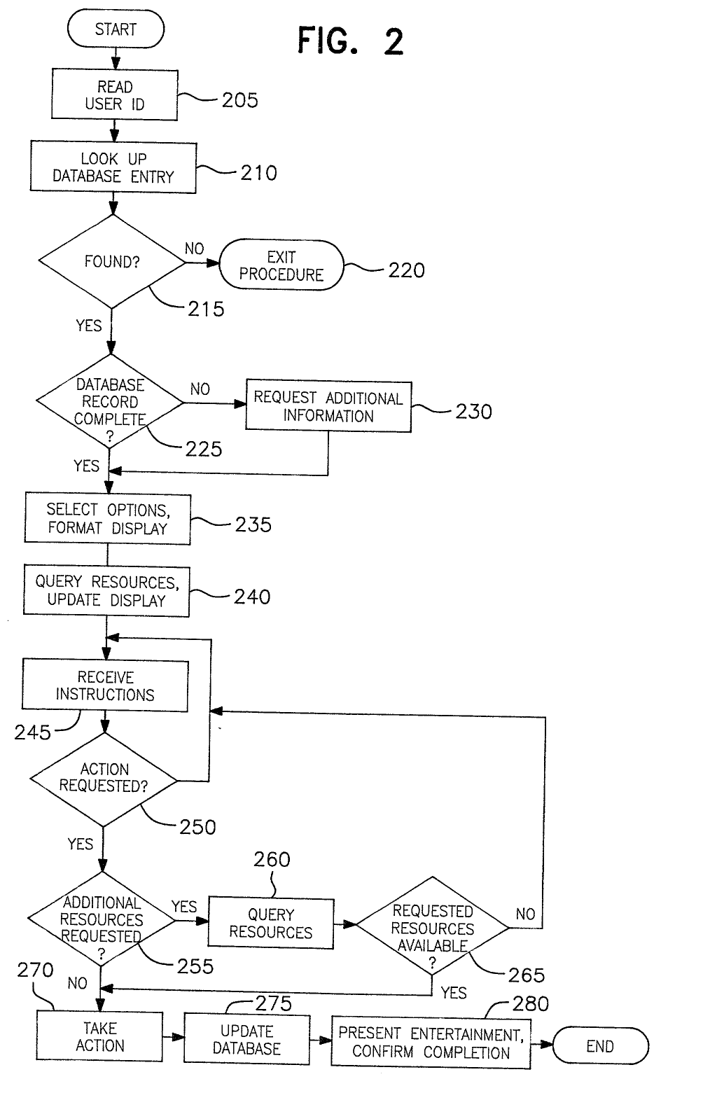

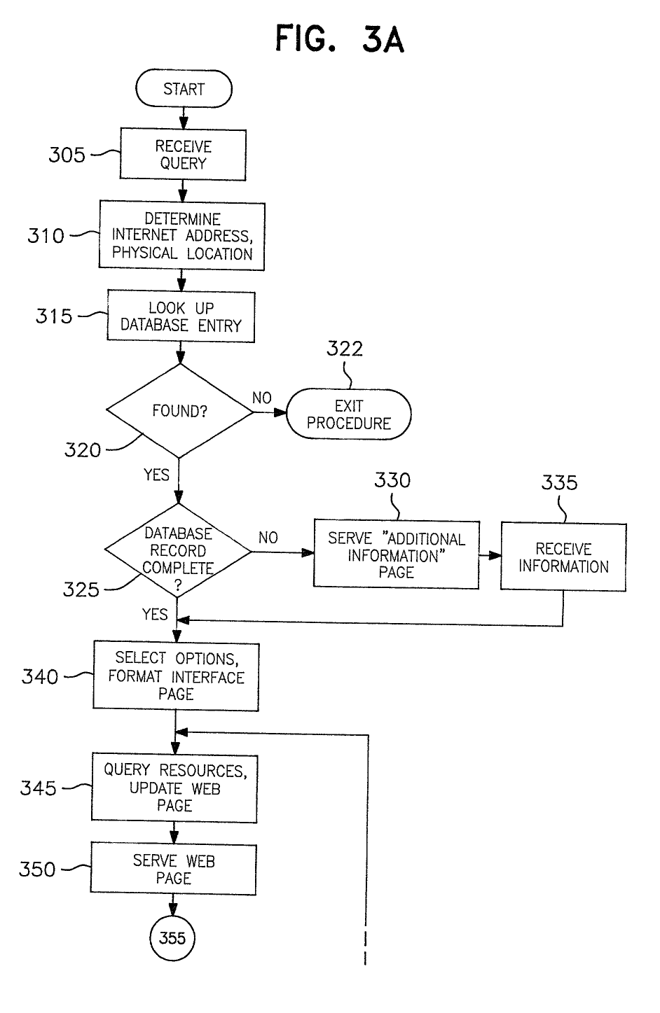

The operation of system 100 is best understood with reference to FIGS. 2 and 3, which illustrate the procedures implemented by control block 142 (FIG. 1) for conventional and web interfaces, respectively. Presentation of an identifier to ID reader 125 triggers execution of the control program, indicated at 200 in FIG. 2. In the first step 205, the user's identifier is read, and database 152 is consulted to find the user's record (step 210). If the record is not found (step 215), the user is informed that his identifier is invalid, and the program aborts (step 220).

If the user's database record is successfully retrieved, the program determines whether it is complete—that is, whether all fields have data. If not, the user is asked to provide additional information (step 230). In a representative implementation, the database records include a user authority level; allowed system resources for the user, given his authority level; resources accessed by the user during his previous session; resources frequently accessed by the user, even if not accessed during the previous session; an interaction language for users whose native language is other than English; a shortcut to network-accessible user document files that the user may select for printing; the user's most recent job request; previous job requests as yet unfulfilled; and entertainment preferences specifying audiovisual content to be presented while the user awaits fulfillment of a job request.

The program then selects options and information to be presented to the user and, using graphics library 145 (FIG. 1), formats a display configured specifically for the user, given the current state of the information in his record (step 235). At the same time, the program queries the resources identified for this user to determine their current availability (step 240). Suppose, for example, that the user's database record reveals that he typically utilizes the system only for digital copying. In this case, program 200 first determines whether this user has any uncompleted jobs, and reports the status of such jobs and/or the date and time of the user's most recently completed job.

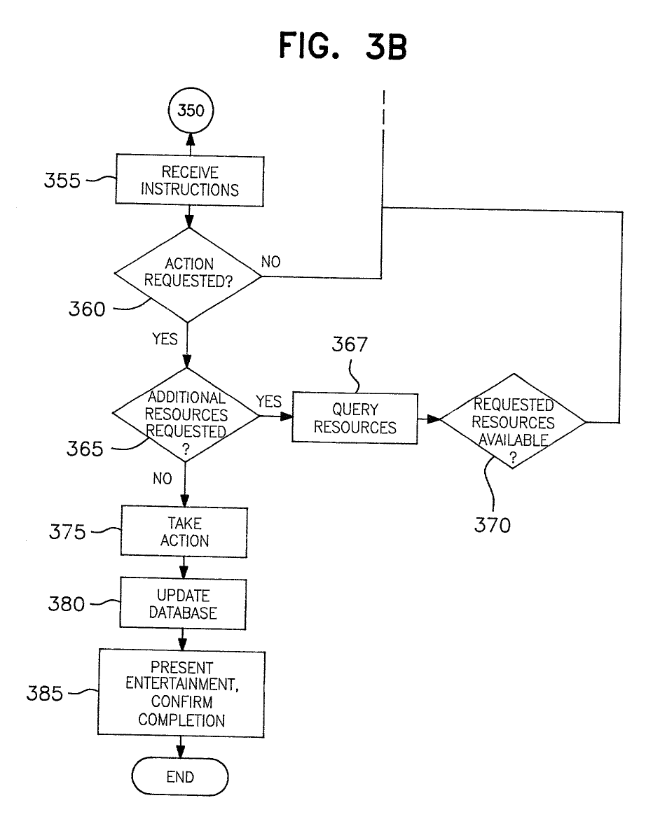

The program may then generate (on display 128) the interface 400 shown in FIG. 4. The graphical entities presented on interface 400 includes a status window 410, which initially displays the scanner and printer most likely to be requested by the user, based on his current physical location and/or the contents of the user's database record. If, for example, the user typically employs the scanner located next to the print server on which the system is implemented (“Scanner 1”) for output on the printer nearest his office (“Printer 7”), this information would appear in status window 410. If the user wishes to change this information, he can touch the “MAIN” icon 415, which is interpreted by user interface 140 (FIG. 1) and passed to the program 200 as an instruction (step 245) to bring up the main menu, which allows the user to select different resources and/or different operations.

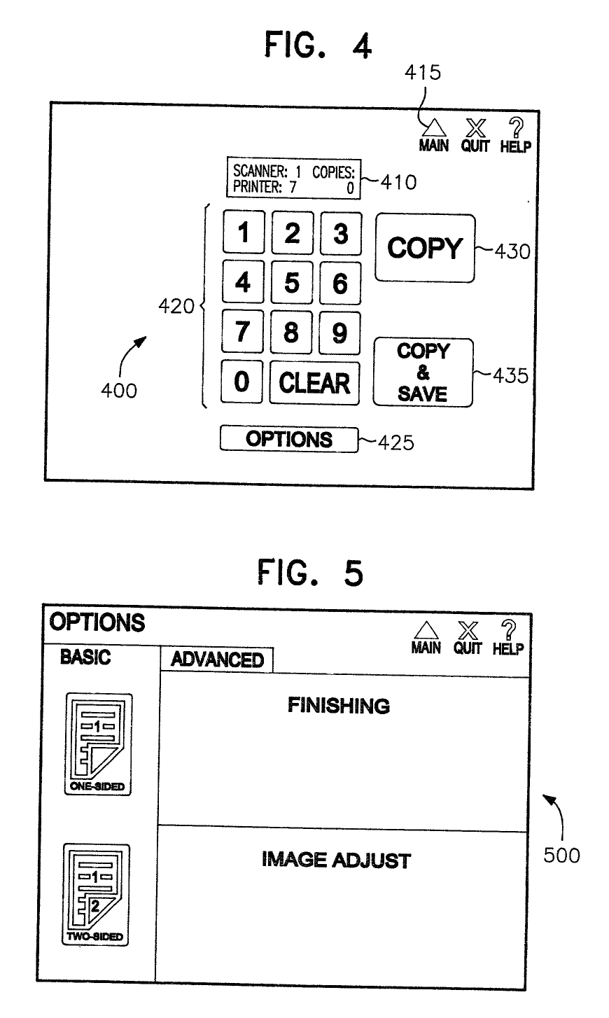

The program may also permit the user to change the parameters associated with the displayed resource. For example, the displayed keypad 420 allows the user to select only the number of copies; the OPTIONS interface shown in FIG. 5 may permit him to vary characteristics associated with the printer or the scanned image. To activate this interface, the user touches the “OPTIONS” icon. The OPTIONS interface 500 allows the user to select the printing format (one-sided or two-sided copies), as well as to vary the finishing characteristics at the printer (print quality, contrast, darkness, etc.) and the characteristics of the scanned image (color balance, gamma, sharpness, etc.).

With renewed reference to FIGS. 2 and 4, the user eventually selects an option designating an action (step 250). For example, the user may select a number of copies using keypad 420, then touch the “COPY” button 430 to request that the documents in the feeder of Scanner 1 be digitized and output to Printer 7. In response to this request, program 200 first determines whether additional resources are required (step 255). Although in this case the answer is negative, program 200 is configured to query, as necessary, any additional resources (step 260) in order to determine their availability (step 265). If the requested resources are not available, the program reports this information to the user, who is invited either to await resource availability or to select alternative options.

If additional resources are either available or unneeded, program 200 takes the requested action (step 270), sending the digital data acquired by Scanner 1(as adjusted by the user by means of interface 500) to Printer 7, along with executable instructions as to number of copies and any printing adjustments requested by the user. The user's database record is updated based on the requested job and the resources involved (step 275). As the user waits for confirmation that the job to complete, program 200 provides the audiovisual content specified in the user's record (step 280).

If the user selects the “COPY & SAVE” button 435 rather than COPY button 430, the user is also provided with the ability to save the digitized document data on file server 175 (FIG. 1); for example, a network user will typically maintain one or more personal folders on the network file server, so will be accorded the option of saving the document in one of these folders (but not someone else's folder). The COPY & SAVE interface might also give the user the option of e-mailing the document via e-mail server 177, and/or converting a scanned document into text characters using optical character recognition software.

A web embodiment 300 of the control program is shown in FIG. 3. In this case, the user and the print server may be located in different buildings or even in different countries, communicating by messages sent over the Internet. In accordance with standard Internet convention, messages are initially broken up into data packets, each of which receives a destination address according to a consistent protocol, and which are reassembled upon receipt by the target computer. A commonly accepted set of protocols for this purpose are the Internet Protocol, or IP, which dictates routing information; and the transmission control protocol, or TCP, according to which messages are actually broken up into IP packets for transmission for subsequent collection and reassembly. TCP/IP connections are quite commonly employed to move data across telephone lines. Alternatively, for consistency with the increasingly utilized Internet, TCP/IP can be implemented as the exchange protocol on a LAN (which may be termed an “intranet”).

The Internet supports a large variety of information-transfer protocols; the web represents one of these. Web-accessible information is identified by a uniform resource locator or “URL,” which specifies the location of the file in terms of a specific computer and a location on that computer. Any Internet “node” —that is, a computer with an IP address (e.g., a server permanently and continuously connected to the Internet, or a client that has connected to a server and received a temporary IP address)—can access the file by invoking the proper communication protocol and specifying the URL. Typically, a URL has the format http://<host>/<path>, where “http” refers to the HyperText Transfer Protocol, “host” is the server's Internet identifier, and the “path” specifies the location of the file within the server. Each “web site” can make available one or more web “pages” or documents, which are formatted, tree-structured repositories of information, such as text, images, sounds and animations.

Thus, in step 305, the print server receives a query sent by the user (or, more specifically, a web browser running as an active process on the user's computer) using http. From the query, the program 300 determines the user's Internet address (step 310) and, by reference to the database, the user's physical location (step 315). It should be emphasized that the database need not reside on the same computer as the print server with which the user communicates; instead, the database may reside on a central server accessed by several print servers by means of a TCP/IP protocol. If the record is not found (step 320), the user is informed that his identifier is invalid, and the program aborts (step 322).

If the user's database record is successfully retrieved and is found to be incomplete (step 325), the user is asked to provide additional information in step 330. This is accomplished by transmitting to the user's browser a new web page containing an interactive form that the user fills out; the user submits the completed form to the print server, thereby causing the web page to transmit the information in the data fields. Receipt by the server of this information activates a CGI application that reads the information and adds it to the database (step 335).

Given the current state of the user's database record (and, possibly, the physical location of the user), program 300 selects options and information to be presented to the user. Using web page templates 147, the program formats a web page display configured specifically for the user (step 340). Program 300 also queries the resources identified for this user to determine their current availability (step 345). The program then serves the web page, which may contain resource availability information, to the user (step 350). In step 355, the program receives instructions from the user based on his interaction with the web page. This is accomplished by code in the web page that recognizes the x,y coordinates of locations on the displayed screen that the user designates (typically through mouse clicks), sending this information to the server. A CGI application on the server determines the meaning of the designated location based on the configuration of the web page that had been presented to the user. If action is required, program 300 determines whether additional resources are required (step 365). If so, the program queries any necessary additional resources (step 367) in order to determine their availability (step 370).

If additional resources are either available or unneeded, the requested action is taken (step 375). Once again, the resources accessed by program 300 may not be local to the print server; indeed, they may be physically closer to the user. Action may be effected by the print server using messages sent to the various resources by means of TCP/IP connections.

Finally, the database is updated (step 380) and entertainment provided to the user (e.g., by means of streaming audio and/or video obtained through an Internet connection to a commercial provider). Completion of the requested action is reported to the user by means of a new or updated web page.

It will therefore be seen that the foregoing approach to distributed digital printing provides substantial flexibility in terms of user specificity and resource allocation. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. An adaptive interface for a digital printing system comprising a plurality of system resources including at least one printer, the interface comprising:
a. means for establishing a user's identity;
b. a database for storing user characteristics;
c. means for causing display of a plurality of interface components based on the characteristics associated with the user in the database, the interface components representing at least one available resource; and
d. means for receiving user commands affecting at least one displayed resource.

2. The adaptive interface of claim 1 wherein the at least one available resource includes at least one printer.

3. The adaptive interface of claim 2 wherein the at least one available resource includes at least one scanner.

4. The adaptive interface of claim 3 wherein the command-receiving means facilitates user selection of a printer and a scanner, the printer, the scanner, and the adaptive interface communicating over a computer network, the interface causing the scanner to transmit scanned data and causing the printer to receive and print the scanned data.

5. The adaptive interface of claim 4 wherein the command-receiving means facilitates user selection of (i) at least one printing characteristic including number of copies and (ii) computer storage of the scanned data.

6. The adaptive interface of claim 1 wherein the database comprises a plurality of sets of cells, each set corresponding to a user, each cell comprising means for storing entries corresponding to a user characteristic.

7. The adaptive interface of claim 6 wherein each cell set comprises cells for storing characteristics of a particular user, said characteristics comprising (i) a user identifier, (ii) a list of resources previously accessed by the user, and (iii) information descriptive of uncompleted tasks previously requested by the user.

8. The adaptive interface of claim 7 wherein the characteristics further comprise a user authority level.

9. The adaptive interface of claim 7 wherein the characteristics further comprise a list of printable files stored on a computer network, the interface facilitating user selection of various ones of the files for printing on a designated print resource.

10. The adaptive interface of claim 7 wherein the command-receiving means facilitates user selection of at least one printing characteristic determined by the characteristics.

11. The adaptive interface of claim 1 wherein the command-receiving means comprises a touch screen, the display-causing means causing display thereon of the interface components as graphical entities whose selection is interpreted as a user command by the command-receiving means.

12. The adaptive interface of claim 11 further comprising a library of graphical entities, the displayed interface components having associated graphical entities retrieved from the library.

13. The adaptive interface of claim 1 wherein the command-receiving means is configured to update the database based on received user commands.

14. The adaptive interface of claim 1 further comprising a web server associated with the display-causing means on a first computer, the command-receiving means being located on a second computer situated remotely from the first computer and connected thereto over a computer network, the display-causing means generating a web page containing the interface components and transmitting the web page to the remotely located command-receiving means for display thereon, the web page receiving user selections as commands and transmitting the commands to the first computer.

15. The adaptive interface of claim 14 wherein the network connection is established by an initial message sent by the second computer to the first computer, the initial message identifying the second computer, the identity-establishing means determining the user's identity from the initial message.

16. The adaptive interface of claim 14 wherein the database is stored on a third computer, the first and third computers communicating over a computer network.

17. A method comprising the steps of:
a. providing a database for storing user characteristics;
b. establishing the user's identity;
c. locating a record in the database corresponding to the user;
d. causing display to the user of a plurality of interface components based on the database record, the interface components representing at least one available resource; and
e. receiving user commands affecting at least one displayed resource.

18. The method of claim 17 wherein the at least one available resource includes at least one printer.

19. The method of claim 18 wherein the at least one available resource includes at least one scanner.

20. The method of claim 19 wherein the user commands include selection of a printer and a scanner, the method further comprising the step of interacting with the scanner and the printer over a computer network based on the user commands so as to (i) cause the scanner to transmit scanned data over the computer network and (ii) cause the printer to receive the scanned data from the computer network and to print the data.

21. The method of claim 20 wherein the user commands include (i) alteration of at least one printing characteristic including number of copies and (ii) computer storage of the scanned data.

22. The method of claim 17 the database record includes fields comprising comprising (i) a user identifier, (ii) a list of resources previously accessed by the user, and (iii) information descriptive of uncompleted tasks previously requested by the user.

23. The method of claim 22 wherein the fields further comprise a user authority level.

24. The method of claim 23 wherein the fields further comprise a list of printable files stored on a computer network, the user commands including selection of various ones of the files for printing on a designated print resource.

25. The method of claim 17 further comprising the step of providing a touch screen on which the plurality of interface components are displayed as graphical entities whose selection is received as a user command.

26. The method of claim 17 further comprising the step of updating the database based on received user commands.

27. The adaptive interface of claim 17 wherein the display-causing step is performed on a first computer and the command-receiving step is performed on a second computer situated remotely from the first computer and connected thereto over a computer network, the method further comprising the steps of generating a web page containing the interface components and transmitting the web page to the second computer, the web page receiving user selections as commands and transmitting the commands to the first computer.

28. The method of claim 27 further comprising the step of establishing the network connection by means of an initial message sent by the second computer to the first computer, the initial message identifying the second computer, the identity-establishing step comprising determining the user's identity from the initial message.

29. The method of claim 27 wherein the database is stored on a third computer, the first and third computers communicating over a computer network.
